(19) United States
(12) Patent Application Publication
(10) Pub. No.: US 2015/0059144 A1
(43) Pub. Date: Mar. 5, 2015

(54) SEALED MOUNTING DEVICE OF AN INTERCHANGEABLE MEMBER ON AN EXTRA STRONG CONTAINMENT ENCLOSURE

(71) Applicant: Getinge La Calhene, Vendome (FR)

(72) Inventors: Bruno Fournier, Saint Ouen (FR); Bernard Chavrot, Athee sur Cher (FR)

(21) Appl. No.: 14/384,787

(22) PCT Filed: Mar. 11, 2013
(86) PCT No.: PCT/EP2013/054855

§ 371 Date: Sep. 12, 2014

(30) Foreign Application Priority Data
Mar. 13, 2012 (FR) 12 52257

(51) Int. Cl. G21F 7/053; B25J 21/02

(52) U.S. Cl. CPC G21F 7/053; B25J 21/02
USPC 29/407.08; 29/705; 29/407.05

(57) ABSTRACT

Device (12) for mounting a glove (106) in a cell flange (4) of a containment cell including a sleeve (14) configured to be attached to the cell; a piston (16) sliding in the sleeve (14); a first seal (18) between the piston (16) and the sleeve (14) so as to ensure tight sliding of the piston (16) in the sleeve (16) and seal the internal passage of the sleeve (14) tightly; control means configured to sliding the piston inside the sleeve; a second seal (20) between the sleeve (14) and the cell wall; the sleeve (14); the piston (16), the first (18) and second seals (20), the cell and the glove (6, 106) forming a detection volume (V); and a sensor (22) of the pressure (22) of the detection volume.

### FIELD OF THE INVENTION AND STATE OF THE RELATED ART

The present invention relates to a sealed mounting device of an interchangeable member of a containment cell offering increased safety.

Toxic substances are handled inside containment enclosures also referred to as glove boxes, which are accessed by means of sealed gloves attached to a wall of the cell to provide protection for the operator.

The open end of a glove through which the operator inserts their hand is mounted on a rigid ring, whereon a seal is mounted.

This assembly consisting of the ring and the seal forms a single-use product, intended to be used on a containment cell, for applications such as handling radioactive substances in the nuclear industry or toxic substances in the pharmaceutical industry.

This assembly is connected to the containment cell via a cell flange previously tightly attached to the cell wall. The cell flange thus defines an opening in the wall, which is sealed tightly by the glove, ring and seal assembly.

When changing a glove, it is necessary to ensure the continuity of the containment, i.e. operator protection. For this, a tool called an “ejection barrel” is used to replace a used glove by a new glove without a breach of containment.

This type of system is particularly described in the patent EP 0418160.

In a context of use of a containment cell with highly toxic substances in powder form, for example radioactive materials, the leakage of a very small quantity of substance when changing glove is considered to be a breach of containment.

Leakages may have multiple causes:

1) it may consist of improper use of the barrel and particularly incorrect positioning thereof giving rise to incorrect positioning of the glove, resulting in a glove wherein the ring axis is not aligned with the cell flange axis,

2) wear of some parts liable to give rise to play in the positioning of the glove along the flange axis, causing migration of contamination due to pumping,

3) the contamination may remain contained downstream from the seal during the use of the glove, but cause migration of contamination when changing glove, when a highly toxic very fine powder material, for example when plutonium, is handled.

The risks associated with the first two causes are reduced considerably for example by means of operator training, by defining operating instructions and by proper management of the expiration dates of the various elements forming the system. Nevertheless, it is always sought to increase the level of safety. Finally, in respect of the last cause, the solutions cited above, in respect of training, operating instructions and the management of expiration dates are ineffective, since this cause is directly associated with the process used in the containment cell: further solutions are thus required.

A breach of containment involves a risk of contamination for operators from the time of the breach of containment to the resolution of the incident. In addition, even when minimal, a breach of containment requires a decontamination operation, the impact whereof may be significant, particularly due to the shutdown of production required during the decontamination step.

### DESCRIPTION OF THE INVENTION

Consequently, one aim of the present invention is that of offering a glove changing device offering a high level of safety during the glove changing step in order to detect any breach of containment, particularly in the event of incorrect positioning of the glove, a glove defect or a migration of powder.

The aim described above is achieved by means of a device for changing an interchangeable member in a flange mounted in a wall of the containment cell comprising a sleeve, a piston translatably mounted in the sleeve, a housing between one end of the piston and one end of the sleeve to receive a new interchangeable member, said end of the piston being suitable for applying a force onto the interchangeable member to cause the positioning thereof in the wall flange, the interchangeable member comprising sealing means engaging with the flange so as to provide a tight contact therewith. The piston is tightly movable in the sleeve and the sleeve is suitable for being in tight contact with the cell flange, so as to define with the interchangeable member a detection volume. The barrel also comprises means for measuring a physical parameters of the interior of the detection volume, the pressure or radioactivity level for example.

In the event of incorrect positioning of the new interchangeable member giving rise to a breach of containment, i.e. a sealing defect between the member and the mounting flange, the contamination is contained in the detection volume.

In the event of a defect of the interchangeable member, for example in the case of a glove, a perforated glove or a sealing defect between the glove and the glove ring or a migration of powder during changing, the contamination is also contained in the detection volume.

Moreover, using the means for measuring a physical parameter for example a measurement of the pressure in the detection volume, it is possible to detect the breach of the containment. Indeed, the interior of the cell is at a different pressure to that of the external environment. The interior of the cell is in negative pressure when handling toxic substances, thus when there is no breach of tightness, the pressure in the detection volume is greater than that in the cell which is a known pressure. In the event of loss of containment, the pressure in the detection volume tends to stabilise with that of the cell, the rate of obtaining equilibrium being even faster than the leakage is large.

In other words, by means of the device for changing an interchangeable member, at least one intermediate sealed zone is created suitable for detecting leakages while maintaining containment.

By means of the invention, immediate detection of a breach of containment when replacing an interchangeable member is performed and containment is maintained until measurements are made.

Advantageously, particularly in the case of a glove, tight contact is provided between the piston and ring of the new glove, to define a further detection volume between the piston and the glove and means for measuring the pressure or the level of radioactivity for example of the additional detection volume. In this way, in the event of a perforated glove, the contamination is contained by the piston and the glove ring, adding an additional level of safety, and the breach of containment is detected.

Advantageously, the device for changing the interchangeable member is such that it is suitable for securing the enclosure while making it possible to maintain containment.

The subject-matter of the present invention thus is a device for mounting at least one interchangeable member tightly in a cell flange of a wall of a containment cell comprising:
a sleeve equipped with one end intended to be attached to the cell,
a piston configured to sliding in an internal passage of the sleeve, the piston sealing the internal passage of the sleeve,
first sealing means between the piston and the sleeve so as to ensure tight sliding of the piston in the sleeve and seal the internal passage of the sleeve tightly,
means configured to sliding the piston inside the sleeve,
second sealing means between the sleeve and the cell wall,
the sleeve, the piston, the first sealing means, the second sealing means, the cell and the interchangeable member forming a detection volume when the mounting device is mounted on the cell wall,
means for measuring at least one physical parameter of the detection volume.

The measuring means comprise for example a pressure sensor of the detection volume and/or a radioactivity detector in the detection volume.

In the case of a radioactivity detector, this may be a gas detector or a silicon diode detector. This detector is then preferably suitable for moving so as to be in close contact with the entire circumference of the detection volume.

The device may advantageously comprise a unidirectional pneumatic connection of an external environment to the detection volume, and means for cutting off said connection. For example, the unidirectional pneumatic connection is provided by a non-return valve and the cutoff means consist of a valve. The device may also advantageously comprise a pneumatic pump connected to the detection volume and means for controlling said pneumatic pump so as to set the pressure of the detection volume to a given value.

The measuring means are for example connected to the detection volume by a connection nozzle via the sleeve.

In one variant embodiment, the unidirectional connection to the detection volume consists of a separate connection nozzle to that of the measuring means to the detection volume and arranged such that it opens between the first sealing means and the interchangeable member when said member is mounted in the sleeve before the mounting thereof in the cell flange.

In a further variant embodiment, the connection of the pneumatic pump and/or unidirectional connection to the detection volume consist of the connection nozzle of measuring means to the detection volume.

In a further example of an embodiment, the mounting device comprises third sealing means between the piston and the interchangeable member so as to provide tight contact between the piston and the interchangeable member. The device may then comprise means for measuring at least one physical parameter of a further detection volume defined by the interchangeable member and the piston when the mounting device is in position on the containment cell. For example, said second measuring means are connected to said volume via the piston.

According to a further feature, the piston comprises a fixed unit tightly mounted in the sleeve and a movable unit intended to apply a force on the interchangeable member, bellows tightly connecting the fixed unit and the movable unit, and the means configured to sliding the piston being rigidly connected to the movable unit. The fixed unit may comprise a ring bearing on the outer periphery thereof the first sealing means in contact with the sleeve, and the movable unit may comprise a piston head. Means configured to sliding the piston may comprise a transmission rod passing through the ring and wherein one end is attached to the piston head. The means configured to sliding the piston are preferably suitable for being detachably rigidly connected to the movable unit.

The second sealing means are preferably borne by a longitudinal end of the sleeve.

Advantageously, the mounting device comprises centring means between the piston and the interchangeable member.

The means configured to sliding the piston are for example connected to motorised actuation means.

Advantageously, the mounting device comprises means intended to emit a visual and/or audio warning signal in the event of the measurement of a physical parameter considered to be abnormal.

In one application, the interchangeable member is a glove.

Another subject-matter of the invention also is a method for mounting an interchangeable member tightly in a containment cell wall by means of a mounting device according to the present invention comprising the following steps:

a) fitting a new interchangeable member in the mounting device,

b) attaching the mounting device on the cell at a cell flange,

c) applying a thrust force on the new interchangeable member by means of the piston until the new interchangeable member is mounted in the cell flange,

d) measuring at least one physical parameter in the detection volume,

e) comparing the measurements of the physical parameter made with given values,

f) detecting a breach of containment or not,

g) removing the mounting device when no breach of containment is detected or retaining the mounting device when a breach of containment is detected and emitting a warning signal.

The method may comprise a first step prior to the step d) for connecting the detection volume with the external environment and a second step prior to the step d) for cutting off said connection.

A step prior to the step d) for establishing a predetermined pressure in the detection volume (V) may advantageously be envisaged.

The method may comprise in the event of detection of a breach of containment, a step f1) for mounting a sealed closure member in the cell flange instead of the new interchangeable member. The sealed closure member may then be a piston.

The method may comprise, during the step f1), the step for fitting a new piston in the sleeve upstream from the piston used for mounting the new interchangeable member, the step for applying a first movement to said new piston so as to mount the piston used for mounting the new interchangeable member in the cell ring, and the step for applying a second movement to the new piston so as to mount the new piston in the cell ring instead of the piston used for mounting the new interchangeable member.

### BRIEF DESCRIPTION OF THE FIGURES

The present invention will be understood more clearly using the following description and the appended figures wherein:

FIG. 1 is a schematically represented longitudinal sectional view of an example of an embodiment of a device for mounting interchangeable members according to the invention,

FIGS. 2A to 2F are schematic representations of various states of the device in the figure when changing glove, if the change is considered to be conforming,

FIGS. 3A to 3K are schematic representations of various states of the device in the figure when changing glove, if the change is considered to be non-conforming,

FIG. 4 is a schematically represented longitudinal sectional view of a further example of an embodiment of a device for mounting interchangeable members according to the invention,

FIG. 5 is a schematically represented longitudinal sectional view of a further example of an embodiment of a device for mounting interchangeable members according to the invention.

### DETAILED DESCRIPTION OF PARTICULAR EMBODIMENTS

The mounting device according to the invention is intended for mounting interchangeable members in a wall of a containment cell, the interchangeable members optionally being gloves for handling inside the cell, caps, members for mounting tools, etc. For the purposes of illustration, hereinafter in the description, we will consider the interchangeable member to consist of a glove, but this is not limiting. It may also consist of an inspection hatch, a bag for introducing equipment into the cell or for disposing of waste, etc.

The terms “upstream” and “downstream” are to be considered in relation to the direction of movement when a change of glove takes place, from left to right as shown in the figures.

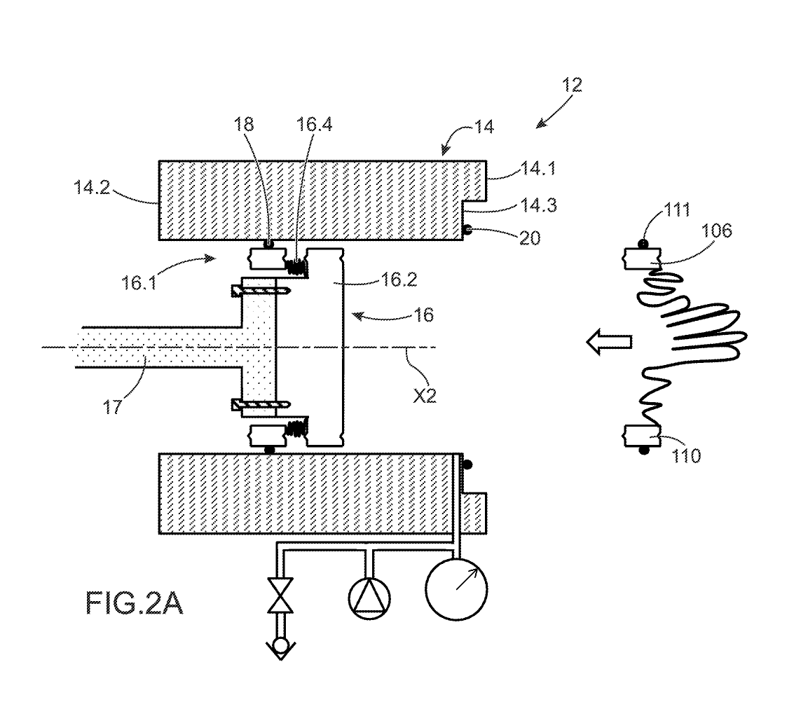

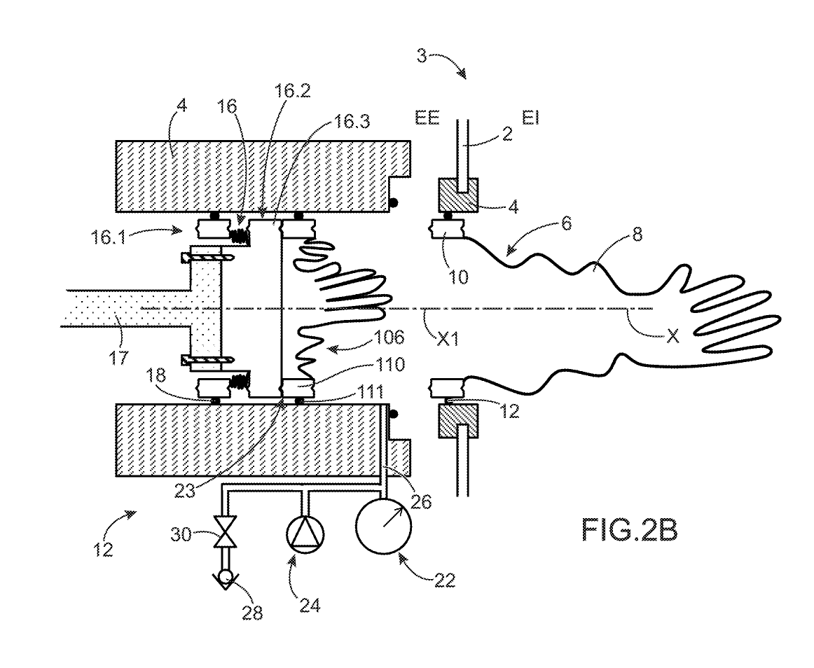

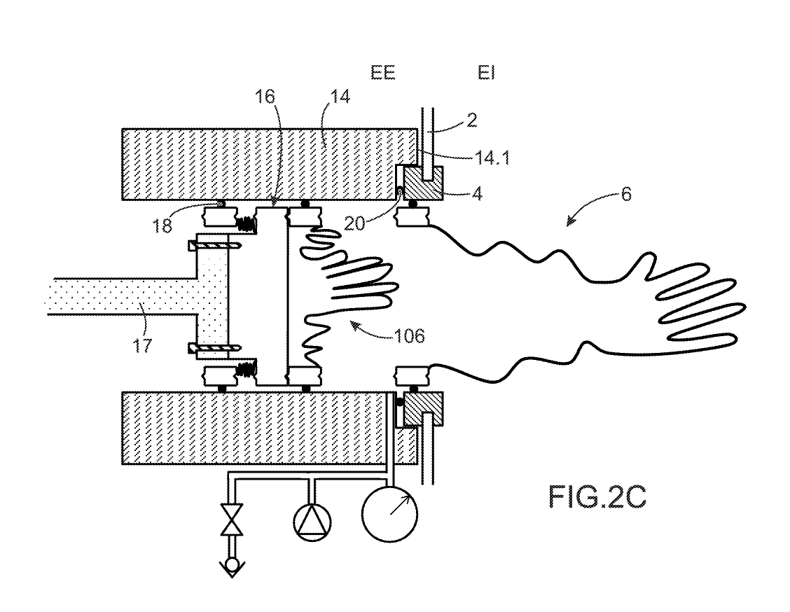

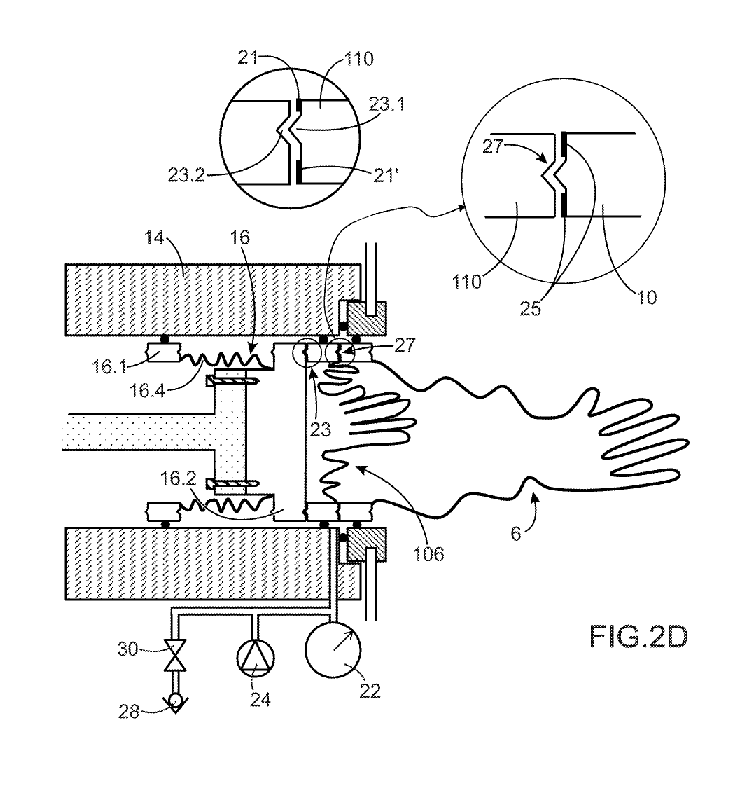

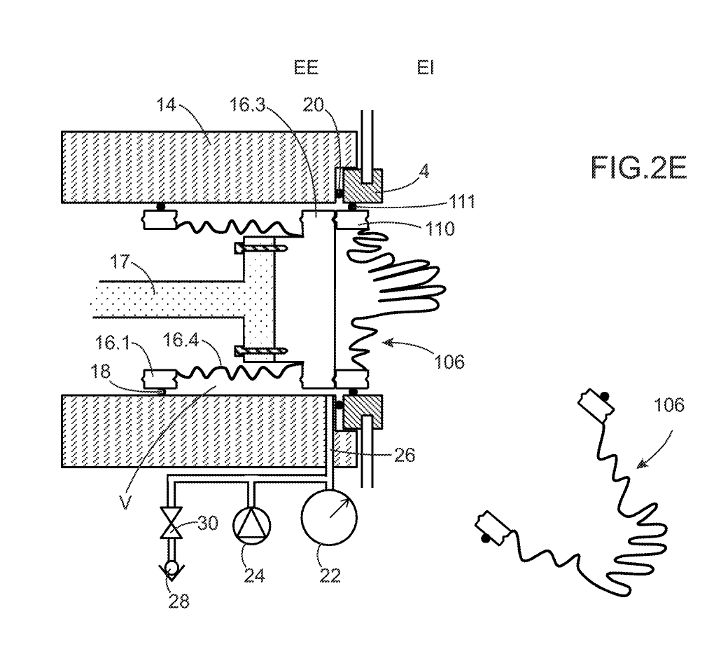

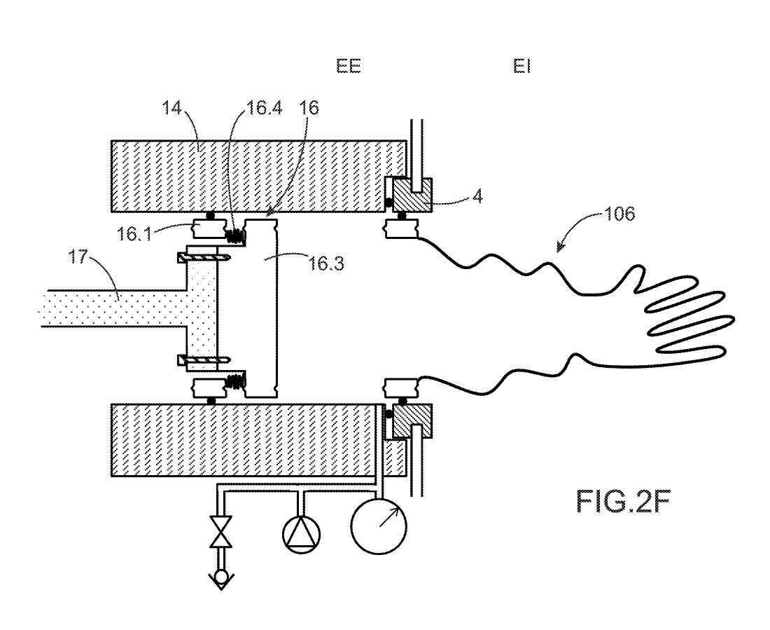

In FIG. 2B, a wall 2 of a containment cell 3, also known as a glove box, equipped with a cell flange 4 can be seen. Preferably, the wall 2 is transparent to enable the operator to view inside the cell. The containment cell 3 defines a sealed inner space EI relative to the external environment EE.

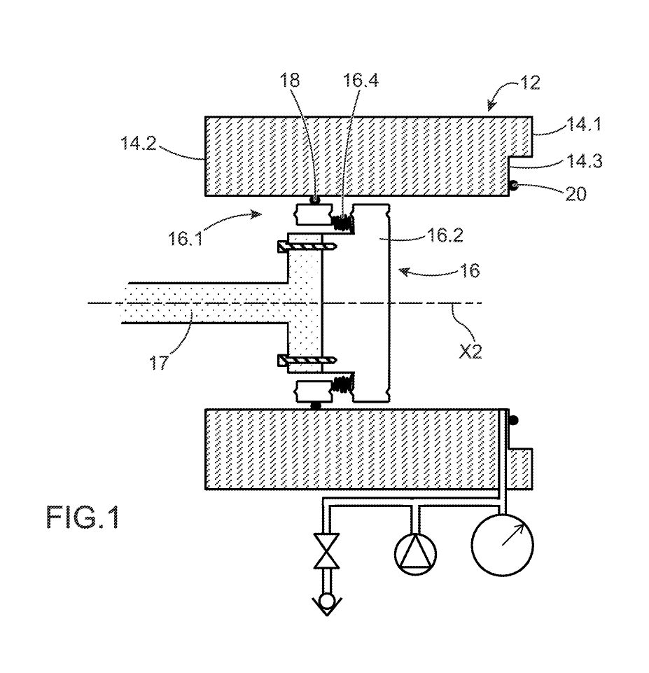

The representation in FIGS. 1, 2, 3 and 4 of the various elements of the cell of the gloves and the glove changing device is schematic and is merely used by way of illustration to aid the comprehension of the invention. Furthermore, the various elements and the clearance between the various elements are not shown to scale.

The cell flange 4 defines a central passage having an axis X, for mounting an interchangeable member 6, which is a glove in the example shown.

The glove 6 comprises a flexible part 8 intended to receive the hand and be arranged inside the glove box and a glove ring 10 bordering an open end of the flexible part 8 through which the operator inserts their hand.

The external diameter of the glove ring 10 is substantially equal to the internal diameter of the cell flange 4. The glove ring 10 comprises on the outer periphery thereof a seal 11 intended to seal between the cell flange 4 and the glove ring 10. The glove ring 10 is represented schematically, it comprises further elements not shown, particularly mechanical means for ensuring the correct positioning thereof, but which are not necessary for understanding the invention.

The glove ring 10 has an axis X1. The glove ring 10 is inserted into the cell flange 4 such that the axis X and the axis X1 are coaxial.

When the glove ring 10 is mounted in the cell flange 4, the assembly formed has an outer face having an annular shape sealed in the central part by the flexible part of the glove.

Preferentially, a part having an annular shape which has been omitted, referred to as a “locking ring”, is mounted on the outer face of the cell flange and glove ring assembly, locking the movement of the glove and preventing any accidental lifting. The locking ring is fitted after fitting a new glove and is removed before changing glove.

In FIG. 1, a glove changing device 12, or “ejection barrel”, can also be seen.

The ejection barrel 12 comprises a tubular shaped sleeve 14 wherein a piston 16 is received in a sliding manner. The sleeve 14 has a longitudinal axis X2.

The sleeve 14 comprises a first longitudinal end 14.1 intended to bear against the cell, against the cell flange 4 or about the cell flange 4. In the example shown, the end 14.1 comprises an annular recess 14.3 housing the cell flange 4 providing guidance when mounting the barrel onto the cell.

The sleeve also comprises a second longitudinal end 14.2 opposite the first longitudinal end 14.1.

Means (not shown) for attaching the sleeve 14 onto the cell are envisaged, for example of the bayonet type for locking the ejection barrel onto the cell and facilitating glove changing.

The piston 16 is mounted configured to sliding in the sleeve 14 along the longitudinal axis X2.

In the rest position as shown in FIG. 1, the piston 16 has a retracted position in the sleeve 14 defining with the sleeve 14 a housing for a new glove 106 (FIG. 2B).

The piston is tightly movably mounted inside the sleeve along the longitudinal axis X2. The piston 16 comprises a fixed unit 16.1 which is normally fixed during a glove changing phase, and a movable unit 16.2 which is normally movable 16.2 during a glove change phase.

The fixed unit 16.1 comprises a ring mounted tightly inside the sleeve 14. Sealing means 18 are mounted on the outer periphery of the fixed unit 16.1.

The movable unit 16.2 comprises a piston head 16.3 coaxial with the axis X2 and provided with a downstream end face 16.3 intended to bear against the glove ring 110 of the new glove 106 and apply a longitudinal force thereon so as to move same along the axis X2 and enable the fitting thereof in the cell flange 4 as explained hereinafter.

A transmission rod 17 is attached to the piston head 16.3 and is intended to transmit a longitudinal force thereto.

The movable unit 16.2 is tightly connected to the fixed unit 16.1. In the example shown, the fixed unit is connected to the movable unit by means of bellow or a rolling membrane 16.4, providing free movement of the movable unit relative to the fixed unit in the sleeve while retaining the sealing.

Advantageously, the internal diameter of the movable unit 16.1 and the external diameter of an upstream portion of the piston head 16.3 of the movable unit are such that the fixed unit ensures longitudinal guidance of the movable unit 16.2 on at least a part of the travel thereof.

Also advantageously, the transmission rod 17 is detachably mounted on the piston head 16.3, for example by screws. The advantage resulting from this feature will emerge hereinafter in the description.

For example, the longitudinal force applied to the transmission rod 17 may be applied directly by the operator. Advantageously, the transmission rod 17 is moved by motorised means, the operator causing the movement of the movable unit 16.2 by actuating a control knob.

Sealing means 20 are provided between the sleeve 14 and the wall 2 of the cell, more particularly between the first longitudinal end 14.1 of the sleeve and the periphery of the passage of the cell flange 4. In the example shown, the sealing means 20 are arranged between the first longitudinal end 14.1 of the sleeve 14 and the cell flange 4. The sealing means 20 consist for example of O-rings or lip seals. By mounting the sealing means 20 on the sleeve 14, the mounting device suitable for checking maintained containment may be used with previous generation cells, as described in the patent EP 0418160. According to a variant, it may be envisaged to arrange the sealing means 20 on the external face of the cell flange 4.

A seal 21 is also provided between the movable unit and the new glove ring to be mounted in the sleeve with a view to the fitting thereof in the cell. For example, it consists of one or a plurality of gaskets borne by a transverse face of the new glove ring as seen in FIG. 2D.

Advantageously, centring means 23 between the piston head 16.3 and the new glove ring are integrated on these two elements. In the example shown, the new glove ring 110 comprises an annular projection 23.1 on the lateral face thereof and the piston head 16.3 comprises an annular groove 23.2 for receiving projection 23.1. Preferably, the seal 21 comprises two gaskets situated inside the annular projection and outside same.

A seal 25 is also preferably embodied between the new glove ring 110 and the used glove ring. Centring means 27 similar to the centring means between the piston head and the new glove ring 110 are envisaged. Preferably, the seal consists of two gaskets situated inside the annular projection and outside same.

In this way, when the new glove 106 is in position in the cell flange 4, instead of the used glove 6, it defines with the sleeve 14, the piston 16, the sealing means 18, the sealing means 20, the cell flange 4 and the sealing means 21 a detection volume denoted V.

The ejection barrel 11 also comprises means 22 for measuring at least one physical parameter of the interior of the detection volume V. Preferably, the physical parameter is the pressure present in the detection volume V, making it possible to check for the existence of a leak as explained hereinafter.

Alternatively or additionally, the physical parameter may be the radioactivity, suitable for detecting the presence of radioactive elements in the cell liable to have entered the detection volume V during the glove change, particularly when the elements consist of fine powder.

In the case of very low-penetration radiation, for example alpha radioactivity, it is desirable for the sensor to be as close to the potential source as possible. In this case, it is envisaged for example to rotate the barrel about the axis X1, so that the sensor also rotates about the axis X1 and is placed in contact with the entire circumference. According to a variant, it could be envisaged that the sensor rotates independently of the barrel.

The measuring means may thus comprise a pressure sensor and/or a radioactivity detector and/or any other detector of a further physical parameter. The choice of detector is dependent on the elements contained in the cell. This list is not restrictive, further sensors suitable for detecting the presence of one or a plurality of chemical compounds, particles, light, etc. may be envisaged.

In the example shown, a radial connection nozzle 26 is embodied via the sleeve 14 for connecting the interior of the detection volume V to the measuring means 22.

Advantageously and as shown in FIG. 1, the device comprises a pneumatic pump 24 for increasing the pressure inside the detection volume V, making it possible to establish a given pressure in the detection volume V. Indeed, the detection volume V being relatively small, it may arise that the initial pressure in the detection volume V after fitting the new glove is variable from one barrel to another, or from one change of glove to another. Consequently, by setting a pressure value by means of a pump, the need for mechanical tolerances of the various parts and the seal compression properties are done away with. The pump 24 may be an electric pump or a manually actuated pump.

In the example shown, the pump 24 is connected to the volume via the radial nozzle 26 of the measuring means 22, simplifying the embodiment of the device and reducing the risk of sealing loss. Also very advantageously and as shown in FIG. 1, the device comprises a supply of air to the volume V ensuring that the pressure in the detection volume V is always greater than or equal to that of the external environment when moving the movable unit 16.2 towards the cell. For this, a non-return valve 28 enabling the entry of air into the volume V is envisaged and a valve 30 between the non-return valve 28 and volume V suitable for cutting off the air flow. The valve 30 may be manually controlled or be motorised. The non-return valve 28 also prevents any emission of contamination.

Advantageously, the air supply is also performed via the radial connection nozzle 26.

According to a variant, it may be envisaged to connect the measuring means 22, the pump 24 and the air supply separately by means of three separate radial connection nozzles via the sleeve.

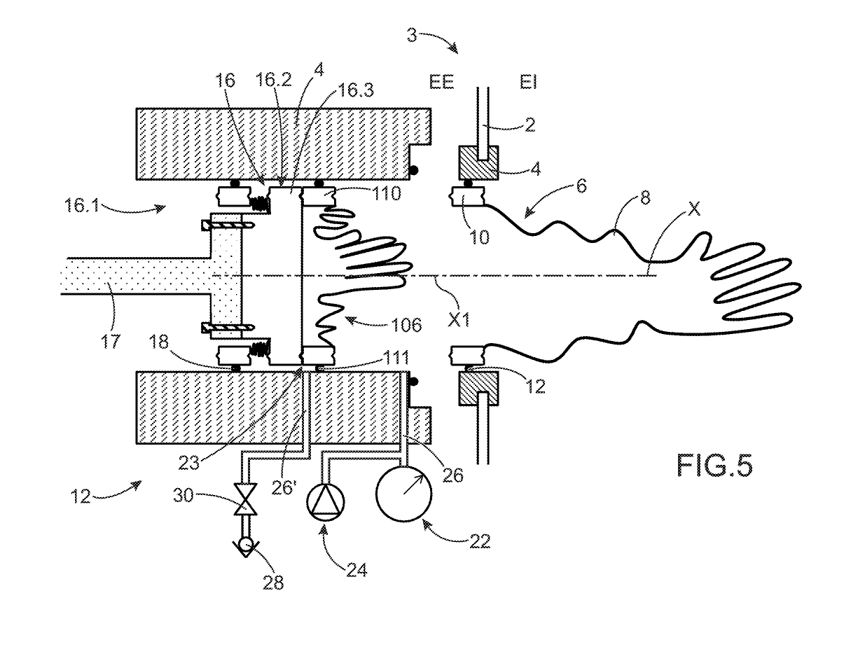

In one advantageous variant embodiment shown in FIG. 5, the barrel comprises a separate connection nozzle 26′ permanently opening between the seal 18 of the fixed unit 16.1 and the seal 111 of the new glove ring 106. In this way, the volume defined between the two seals 118 and 111 is permanently connected to the external environment via the non-return valve 28 and the valve 30 and the appearance of a negative pressure in this volume is prevented when moving the movable unit and the new glove ring 106. The non-return valve also prevents the potential emission of contamination.

Replacing a glove by means of the ejection barrel equipped with a pressure will now be described using FIGS. 2A to 2F. The example includes a cell wherein the inner volume is in negative pressure relative to the exterior, for example when handling radioactive elements.

Replacement is performed as follows: the operator fits a new glove 106 in the sleeve 14 on the side of the first longitudinal end 14.1 of the sleeve 14 (FIG. 2A). The piston is in the retracted position.

During a following step, the operator moves the barrel towards the cell flange 4 bearing the used glove 6 (FIG. 2B).

The seal 20 borne by the first end 14.1 of the sleeve 14 bears against the cell flange 4. The mounting is guided by the annular reinforcement 14.3. The operator then attaches the ejection barrel onto the cell flange 4 of the glove to be replaced, for example using a bayonet system such that the axes X, X1 and X2 are coaxial. The seal 20 is then compressed and the sealing between the sleeve 14 and the cell flange 4 is confirmed (FIG. 2C)

The operator then actuates the piston 16 by applying a force onto the transmission rod 17 so as to move the movable unit 16.2 along the axis X2 towards the cell flange 4. The downstream face of the piston head 16.3 of the movable unit 16.2 comes into contact with the new glove ring 110, the relative arrangement of the piston head 16.3 and the new glove ring 110 is fixed by the centring means 23. The new glove ring 110 is then moved towards the cell flange 4. The new glove ring 110 in turn bears against the used glove ring 10 (FIG. 2D).

Under the effect of the movement of the piston 16, the new glove ring 110 pushes the used glove ring 10 towards the interior of the cell 3 until it ejects and replaces same. The new glove ring 110 is then tightly mounted in the cell flange 4 (FIG. 2E).

When the new glove ring 110 is mounted in the cell flange 4, the connection nozzle 26 opens into the detection volume V. At this stage of the glove changing procedure, the valve 30 is opened, air is then admitted via the non-return valve 28 into the detection volume V preventing any appearance of negative pressure in the detection volume V.

As explained above, when the new glove 106 is fitted in the cell flange 4, the sleeve 14, the piston 16, the sealing means 18, the sealing means 20, the cell flange 4, the new glove ring 110 and the sealing means 21 define the detection volume V. The connection nozzle 26 opens into the detection volume V, the pressure sensor 22 is then suitable for measuring the pressure of the detection volume V. The operator waits for the pressure to stabilise in the detection volume V. The negative pressure in the cell is typically between −50 Pas and −150 Pa relative to the external environment. In the event of leakage, the pressure does not stabilise, but changes to tend towards the cell pressure. The drop in pressure for a predetermined time, for example one minute, is then measured. The acceptable pressure drop values in the detection volume V are determined experimentally according to the facility and the leakage level deemed acceptable. The typical values vary between 1 Pascal per minute (Pa/min) and several hundred (Pa/min).

In the example shown, the operator may actuate the pump 24 to achieve a predetermined pressure and thus do away with the need for stabilisation. The valve 30 has been closed beforehand.

The pump 24 is shut down and the pressure measurement is made.

The start-up of the pump 24 and/or the pressure measurement may be controlled manually by the operator or be controlled by a central unit automatically, along with the status of the valve 30.

When the glove 106 is sealed and the seal 111 is in tight contact with the glove ring 110 and the cell flange 4, the pressure in the detection volume V is greater than that present in the cell 3. This infers that there is no breach of containment. When no breach of containment is detected, the movable unit 16.2 of the piston 16 is retracted to return to the rest position thereof (FIG. 2F) and the barrel is removed and a locking ring is fitted on the cell flange 4 and the new glove ring 110. The glove is ready for use.

If the pressure measurement and/or any other representative parameter of the sealing of the assembly shows a non-conforming situation, the procedure is continued as explained below. A non-conforming measurement occurs for example if the new glove ring is mounted incorrectly in the cell flange, the pressure in the detection volume V then stabilises at around that of the cell. When the pressure sensor 22 measures such a pressure in the detection volume V, a breach of containment is signalled. If the barrel comprises a radioactivity detector, the presence of radioactive elements is detected in the detection volume V, for example in the event of powder migration. Such detection causes the emission of a warning signal, for example of the audio and/or light type. A warning message may be sent to a central unit.

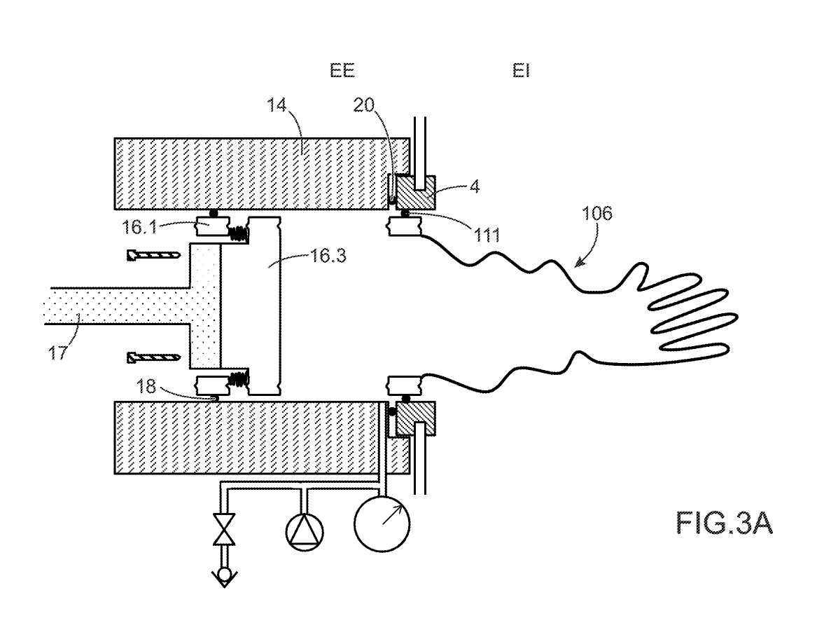

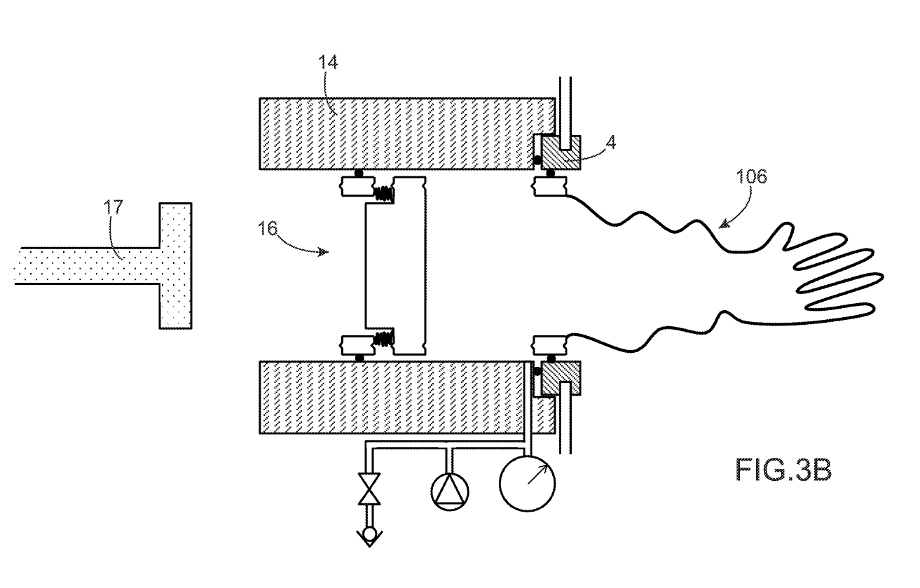

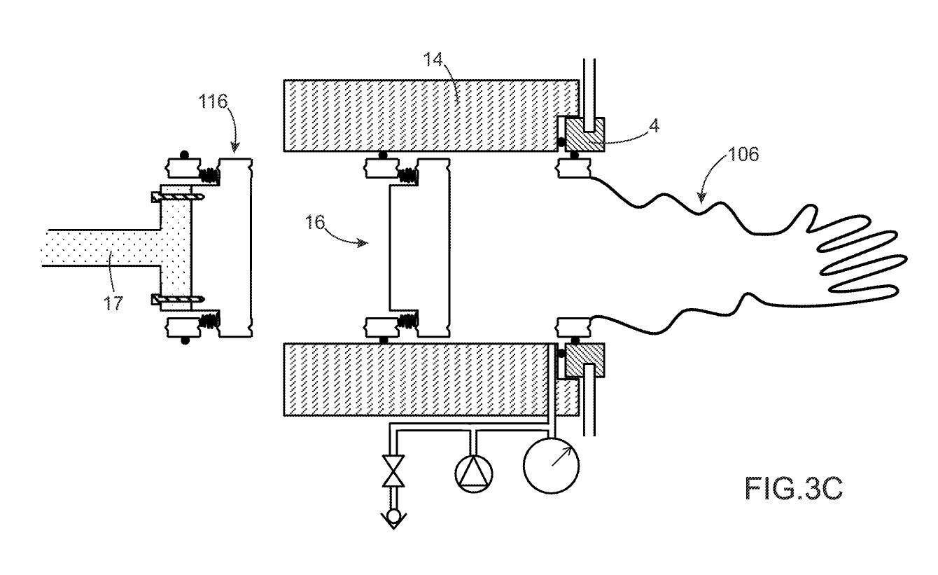

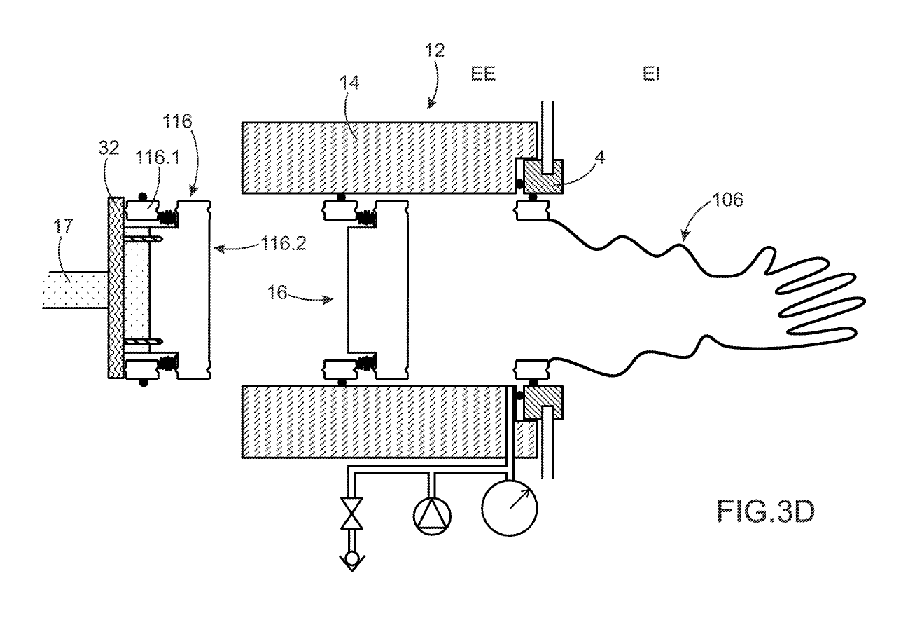

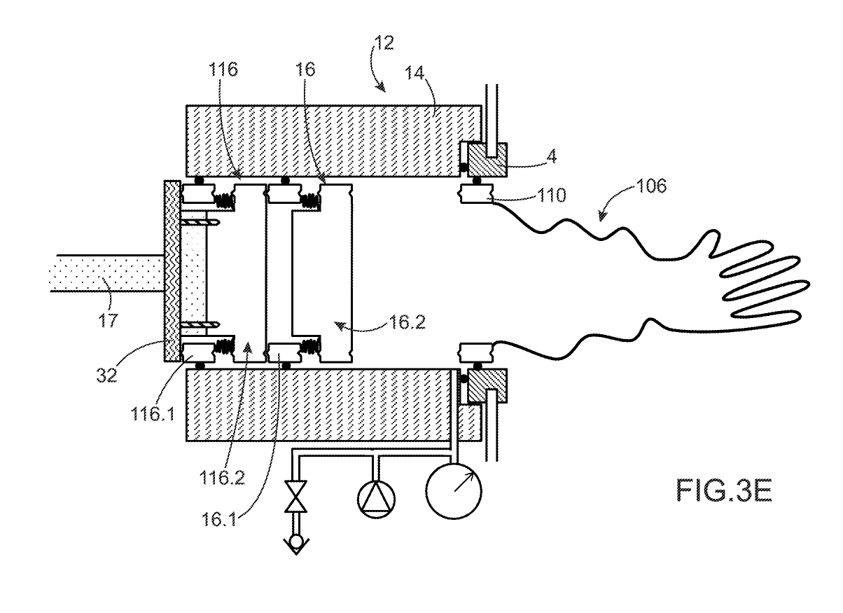

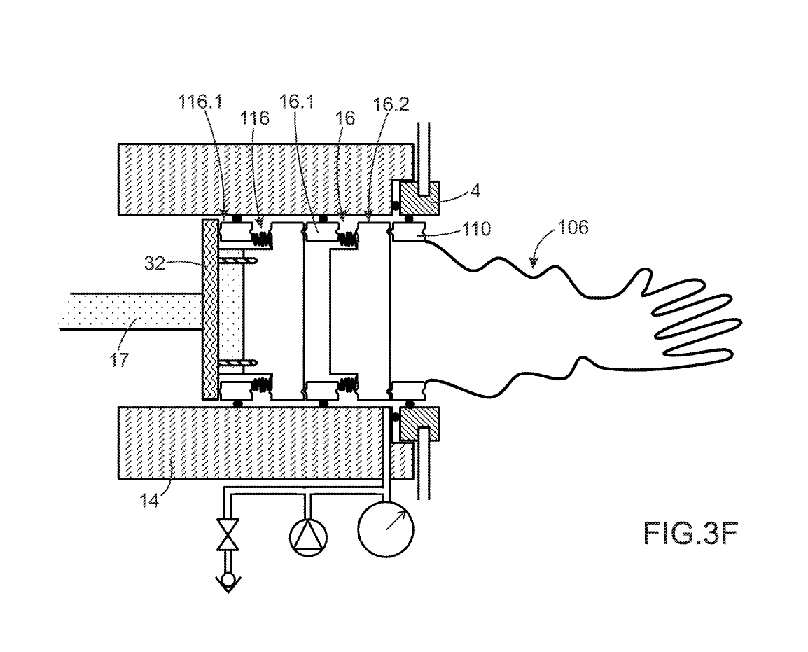

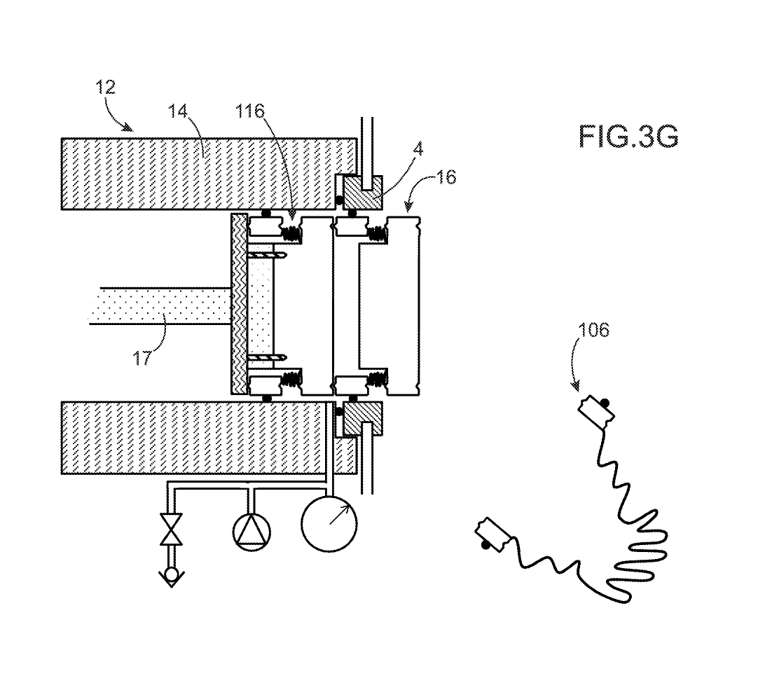

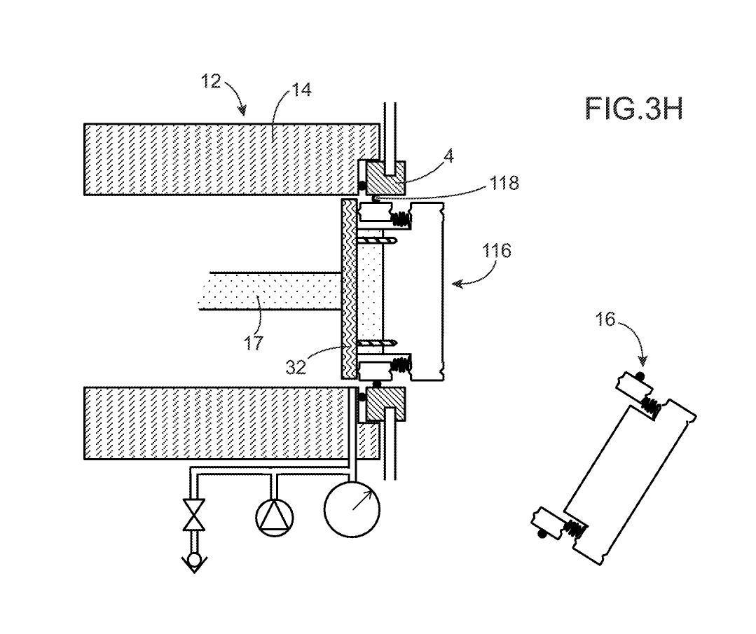

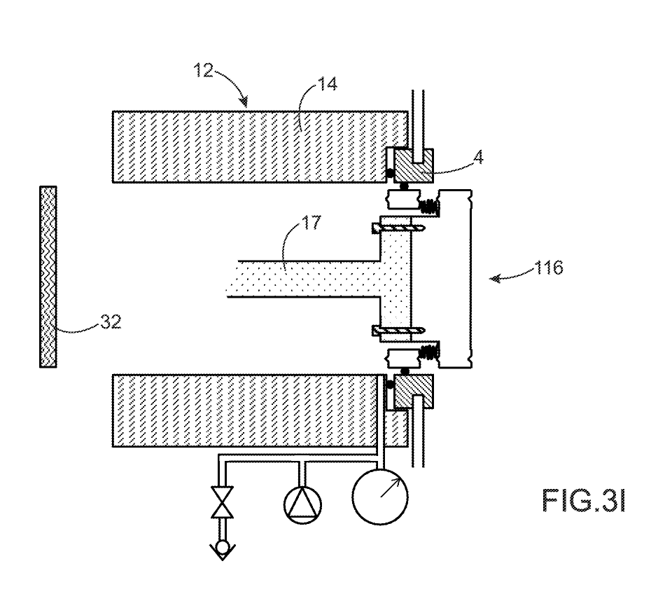

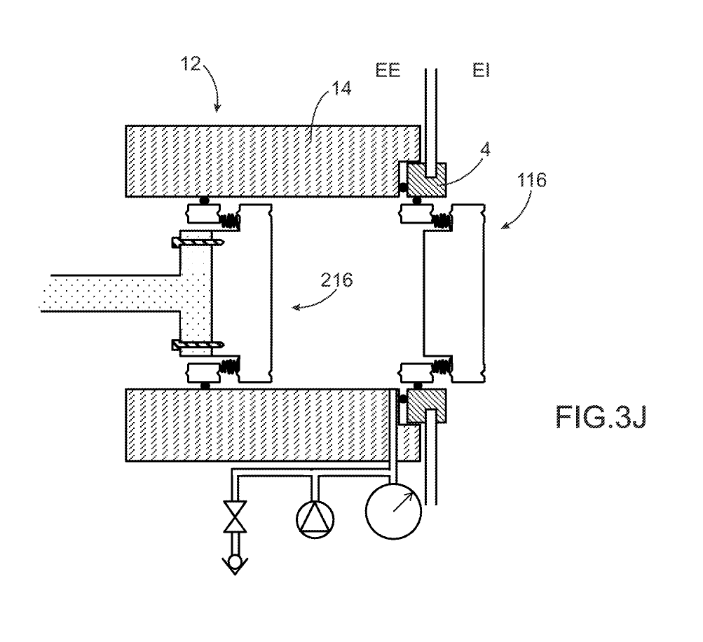

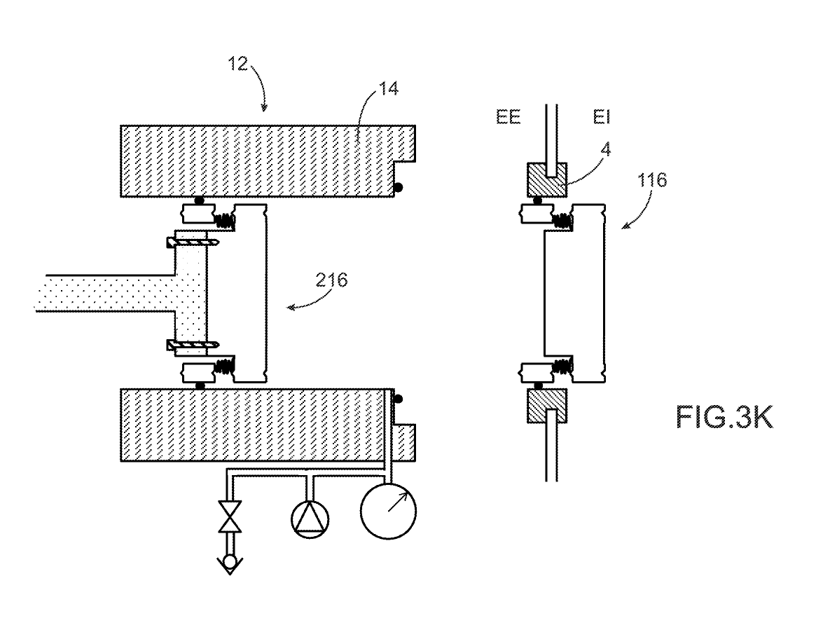

The movable unit 16.2 of the piston is retracted to return to the rest position thereof. The transmission rod 17 is then detached from the piston head 16.3 for example by unfastening the screws (FIG. 3A).

The transmission rod is then removed from the sleeve 14 via the second end 14.2 thereof and is inserted (FIG. 3B).

During a subsequent step, the transmission rod 17 is rigidly connected to the movable unit 116.2 of a new piston 116 (FIG. 3C).

A support plate 32 is attached to the transmission rod so as to be axially rigidly connected thereto and such that it bears against an upstream face of the ring of the fixed unit 116.1 to cause the axial movement thereof with the movable unit 116.2 (FIG. 3D).

Then. the new piston 116 is mounted in the sleeve 14 to the rear of the used piston 16 (FIG. 3E). The piston head 16.3 is then bearing against the upstream face of the ring of the fixed unit 116.1 of the used piston 16. Advantageously, centring means are envisaged between the piston head of the new movable unit 116.2 and the upstream face of the ring of the fixed unit 16.2 of the used piston 16.

A thrust force applied to the transmission rod 17 towards the cell, which moves the movable unit 116.2 and the fixed unit 116.1 via the support plate 32. The used piston 16 is then also moved towards the cell, until it bears against the glove ring 110 mounted in the cell (FIG. 3F).

This movement causes the ejection of the glove ring 110 towards the interior of the cell and the ring assembly of the fixed unit of the used piston 16 is in position in the cell flange 4 (FIG. 3G).

Preferably, the thrust force is continued until the used piston 16 is also ejected towards the interior of the enclosure and the ring of the fixed unit 116.1 of the new piston 116 is in position in the cell flange 4 (FIG. 3H). Indeed, according to the type of seal borne by the ring of the fixed unit, for example a lip seal, the fixed unit cannot move downstream to upstream while maintaining sealing. It is then preferable to eject the piston 16 and mount the piston 116 in the cell flange. If the seal 118 enables a secure downstream to upstream movement, it is possible to retract the fixed unit from the piston 116 and leave the piston 16 in position in the cell ring 4. Using a suitable seal technology, for example a two-lip seal or a quadrilobe seal, it is possible to produce bidirectional sealing.

During a subsequent step, the support plate 32 is removed, along with the transmission rod 17 (FIG. 3I).

At this stage, the barrel 12 may be removed in complete safety.

However, it is possible to envisage refitting a piston 216 in the barrel before detaching the barrel from the cell, to render same operational again. This is performed as for the mounting of the piston 116. The fixed unit is moved axially to the working position thereof similar to that in FIG. 1. The barrel is then operational again (FIG. 3J) and may be detached from the cell (FIG. 3K).

The piston 16 forms a cap for the cell flange 4 and may be replaced at any time by a glove, a cap or any other equipment according to the steps in FIGS. 2A to 2F.

According to a variant, it could be envisaged instead of fitting a piston 116 in the cell flange to mount a cap directly.

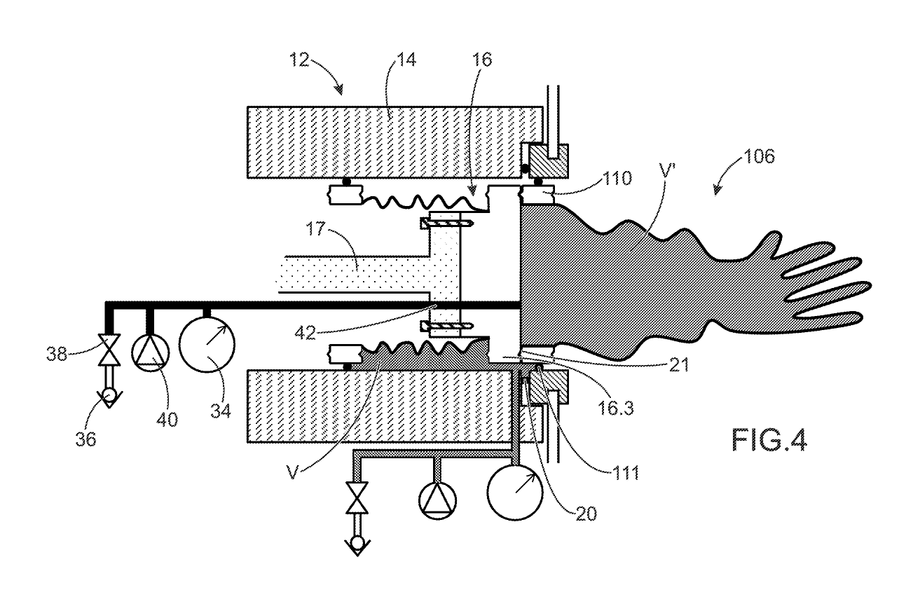

In FIG. 4, an example of an embodiment of a device according to the invention wherein means are envisaged for checking the sealing of the new glove. For this, means for measuring pressure or another parameter are connected to the internal volume V′ of the new glove defined by the flexible part of the new glove, the new glove ring, the seals and the piston head. The measuring means 34 are connected to the volume V′ via the piston 16 by means of passage 42. Advantageously, a pump 40 is envisaged, along with a non-return valve 36 and a valve 38.

The valve 36 allows air to circulate from the operator zone to the interior of the glove, and helps prevent the creation of negative pressure inside the glove, which is a phenomenon liable to occur when the used glove 6 is ejected and the new glove 106 can be extended inside the cell. In this way, in the event of leakage in the glove, any risk of suction from the contaminated interior environment EI of the cell towards the exterior EE is prevented.

Advantageously, it is possible to envisage using the measuring means, the pump, the non-return valve and the valve used for the detection volume V. The measurement procedure is similar to that described with the means 22, 24, 28 and 30.

If a non-conforming measurement is made, for example if the flexible part is perforated, the pressure in the volume V′ tends to stabilise at around that of the cell or the presence of radioactive elements is detected in the volume V′, the procedure is continued according to the steps represented in the FIGS. 3A to 3K.

The presence of the detection volume V has the further advantage of forcing back the elements normally contained in the cell towards the interior of the cell, increasing the level of safety even in the event of breach of containment. Indeed, creating a detection volume V results in an increase in the pressure, particularly after a glove change. The difference in pressure between the interior of the cell and the detection volume is thus increased. In this way, in the event of leakage, the glove change will induce an air flow oriented towards the interior of the cell, which forces back the contamination towards the interior of the cells.

When a breach of containment is detected, the containment remains ensured by the presence of the ejection barrel, particularly of the sealing means 18 and 20. The installation remains completely secure. It may be envisaged on the detection of a breach of containment, that the barrel is locked on the cell until the measurements are made to restore the containment, for example it may be envisaged that a pin is released and prevents the bayonet attachment from being unlocked.

The detection of the breach of containment occurs without delay after the glove is mounted. Measures may then be taken to handle this breach of containment, either by holding the barrel in position to handle the breach of containment later, the access via this cell flange is then temporarily locked making it possible not to prevent access to the cell by other flanges, or by immediately evacuating the room containing the cell to decontaminate the contaminated zone and restore the containment.

What is claimed is:

1-27. (canceled)

28. Device for mounting at least one interchangeable member tightly in a cell flange of a wall of a containment cell comprising:
a sleeve equipped with one end configured to be attached to the cell,
a piston configured to sliding in an internal passage of the sleeve, the piston sealing the internal passage of the sleeve,
a first seal between the piston and the sleeve so as to ensure tight sliding of the piston in the sleeve and seal the internal passage of the sleeve tightly,
means configured to sliding the piston inside the sleeve,
a second seal between the sleeve and the cell wall,
the sleeve, the piston, the first seal, the second seal, the cell and the interchangeable member forming a detection volume when the mounting device is mounted on the cell wall,
at least one sensor for measuring at least one physical parameter of the detection volume.

29. Mounting device according to claim 28, wherein the at least a sensor comprises a pressure sensor of the detection volume and/or a radioactivity detector in the detection volume.

30. Mounting device according to claim 29, wherein the radioactivity detector is a gas detector or a silicon diode detector.

31. Mounting device according to claim 30, wherein the radioactivity detector is suitable for moving so as to be in close contact with the entire circumference of the detection volume.

32. Mounting device according to claim 29, comprising a pneumatic pump connected to the detection volume and a controller for controlling said pneumatic pump so as to set the pressure of the detection volume to a given value.

33. Mounting device according to claim 28, comprising unidirectional pneumatic connection of an external environment to the detection volume, and a valve for cutting off said connection.

34. Mounting device according to claim 33, wherein unidirectional pneumatic connection is provided by a non-return valve.

35. Mounting device according to claim 28, wherein the at least a sensor is connected to the detection volume by a connection nozzle through the sleeve.

36. Mounting device according to claim 33, wherein the at least a sensor is connected to the detection volume by a connection nozzle through the sleeve and wherein the unidirectional connection to the detection volume consists of a separate connection nozzle to that of the at least a sensor to the detection volume and arranged such that it opens between the first seal and the interchangeable member when said member is mounted in the sleeve before the mounting thereof in the cell flange.

37. Mounting device according to claim 32, comprising unidirectional pneumatic connection of an external environment to the detection volume, and the valve for cutting off said connection and wherein the at least a sensor are connected to the detection volume by a connection nozzle through the sleeve and wherein the connection of the pneumatic pump and/or unidirectional connection to the detection volume is the connection nozzle of the at least a sensor to the detection volume.

38. Mounting device according to claim 28, comprising third seal between the piston and the interchangeable member so as to provide tight contact between the piston and the interchangeable member.

39. Mounting device according to claim 38, comprising a second sensor for measuring at least one physical parameter of a further detection volume defined by the interchangeable member and the piston when the mounting device is in position on the containment cell.

40. Mounting device according to claim 39, wherein said second sensor is connected to said volume through the piston.

41. Mounting device according to claim 28, wherein the piston comprises a fixed unit tightly mounted in the sleeve and a movable unit configured to apply a force on the interchangeable member, bellows tightly connecting the fixed unit and the movable unit, and the means configured to sliding the piston being rigidly connected to the movable unit.

42. Mounting device according to claim 41, wherein the fixed unit comprises a ring bearing on the outer periphery thereof the first seal in contact with the sleeve, and the movable unit comprises a piston head, and wherein the means configured to sliding the piston comprise a transmission rod passing through the ring and wherein one end is attached to the piston head.

43. Mounting device according to claim 41, wherein the means configured to sliding the piston are detachably rigidly connected to the movable unit.

44. Mounting device according to claim 28, wherein the second seal is borne by a longitudinal end of the sleeve.

45. Mounting device according to claim 28, comprising centring means between the piston and the interchangeable member.

46. Mounting device according to claim 28, wherein the means configured to sliding the piston are for example connected to motorised actuation means.

47. Mounting device according to claim 28, comprising a apparatus connected to the at least one sensor for measuring at least one physical parameter of the detection volume which is configured to emit a visual and/or audio warning signal in the event of the measurement of a physical parameter considered to be abnormal.

48. Mounting device according to claim 28, wherein the interchangeable member is a glove.

49. Method for mounting an interchangeable member tightly in a containment cell wall by means of a mounting device according to claim 28, comprising the steps:
a) fitting a new interchangeable member in the mounting device,
b) attaching the mounting device on the cell at a cell flange,
c) applying a thrust force on the new interchangeable member by means of the piston until the new interchangeable member is mounted in the cell flange,
d) measuring at least one physical parameter in the detection volume,
e) comparing the measurements of the physical parameter made with given values,
f) detecting a breach of containment or not,
g) removing the mounting device when no breach of containment is detected or retaining the mounting device when a breach of containment is detected and emitting a warning signal.

50. Mounting method according to claim 49, comprising a first step prior to the step d) for connecting the detection volume with the external environment and a second step prior to the step d) for cutting off said connection.

51. Mounting method according to claim 49, comprising the step d) for establishing a predetermined pressure in the detection volume.

52. Mounting method according to claim 49, comprising in the event of detection of a breach of containment, a step f1) for mounting a sealed closure member in the cell flange instead of the new interchangeable member.

53. Mounting method according to claim 52, wherein the sealed closure device is a piston.

54. Mounting method according to claim 53, comprising, during the step f1), the step for fitting a new piston in the sleeve upstream from the piston used for mounting the new interchangeable member, the step for applying a first movement to said new piston so as to mount the piston used for mounting the new interchangeable member in the cell ring, and the step for applying a second movement to the new piston so as to mount the new piston in the cell ring instead of the piston used for mounting the new interchangeable member.
